(19) United States
(12) Patent Application Publication
(10) Pub. No.: US 2009/0169852 A1
(43) Pub. Date: Jul. 2, 2009

(54) CONDUCTIVE ADHESIVE TAPE HAVING DIFFERENT ADHESION ON BOTH SURFACES AND METHOD FOR MANUFACTURING THE SAME

(76) Inventors: Jeongwan Choi, Kyonggi-do (KR); Un Nyoung Sa, Gyongki-do (KR)

Correspondence Address: 3M INNOVATIVE PROPERTIES COMPANY, PO BOX 33427, ST. PAUL, MN, 55133-3427, US

(21) Appl. No.: 12/304,474

(22) PCT Filed: Jun. 28, 2007
(86) PCT No.: PCT/US07/72305

§ 371 Date: Dec. 12, 2008

(30) Foreign Application Priority Data
Jul. 4, 2006 (KR) 10-2006-0062457

(51) Int. Cl. C09J 7/02; H01B 5/00; H01B 1/12; H01B 1/22

(52) U.S. Cl. 428/220; 442/1; 252/500; 252/514; 252/602

(57) ABSTRACT

Disclosed is an electroconductive adhesive tape having different adhesion values on both surfaces thereof. A method for producing the same is also disclosed. The adhesive tape has different adhesion values on both surfaces thereof, elasticity, and electroconductivity along the longitudinal direction as well as the transverse direction. Thus, the adhesive tape can be used in electronic components, as an electromagnetic wave-shielding tape that permits easy attachment/detachment.

### BACKGROUND OF THE INVENTION

1. Field of the Invention

The present invention relates to an electroconductive adhesive tape having different adhesion values on both surfaces thereof and a method for manufacturing the same. More particularly, the present invention relates to an adhesive tape, which has electroconductivity along its longitudinal direction as well as on transverse direction and shows different adhesion values on both surfaces thereof, thus can show easy peel-off property if desired, and to a method for manufacturing the adhesive tape.

2. Description of the Prior Art

In general, the following methods have been used in order to impart conductivity to an adhesive tape.

First, when fabricating an adhesive, fine conductive powder such as carbon black, graphite, silver, copper, nickel or aluminum is uniformly distributed in the adhesive as conductive fillers. However, in order to impart conductivity to the adhesive by using the conductive fillers, particles of the conductive fillers must form a consecutive pathway in a polymer resin for forming the adhesive. That is, in the case of an adhesive fabricated by a conventional process, an excessive amount of conductive fillers are required to impart sufficient conductivity. However, in this case, it is difficult to uniformly distribute particles of carbon black, and melt viscoelasticity of an adhesive resin is reduced, so that filler particles may adhere with each other, thereby significantly increasing viscosity. As a result, the specific gravity of the resultant product is increased while deteriorating the physical properties of the product, so that the impact and vibration absorbing property of the product may be degraded. Meanwhile, even if such an excessive amount of conductive fillers is used, it is often difficult to obtain electroconductivity to a sufficient degree.

Meanwhile, it is sometimes necessary to remove an adhesive from electric/electronic products so as to attach/detach such products to/from each other, while not adversely affecting the products themselves, when the products are to be discarded or when the products are misassembled during the manufacture thereof. Also, an adhesive may be required to show a strong adhesion value on one surface while showing a low adhesion value or no adhesion value on the other surface. To accomplish this, according to the prior art, it has been suggested to use a substrate sheet for the manufacture of an adhesive tape, and then to apply an adhesive onto one surface of the substrate sheet or to apply different kinds of adhesives having different adhesion values onto both surfaces thereof.

### SUMMARY OF THE INVENTION

It is an object of the present invention to provide an adhesive tape having different adhesion values on both surfaces thereof. It is another object of the present invention to provide a method for imparting electroconductivity to an adhesive tape having different adhesion values on both surfaces thereof along its transverse direction as well as its longitudinal direction in order to provide more effective conductivity to the adhesive tape.

It is still another object of the present invention to provide an adhesive tape, which shows conductivity along its transverse direction as well as its longitudinal direction and has different adhesion values on both surfaces thereof.

It is yet another object of the present invention to provide a method for producing an adhesive tape, which shows conductivity along its transverse direction as well as its longitudinal direction and has different adhesion values on both surfaces thereof.

The present invention provides an adhesive tape, which comprises an adhesive polymer resin and conductive fillers distributed in the adhesive polymer resin, and has different adhesion values on both surfaces thereof, wherein the conductive fillers are aligned in both longitudinal and transverse directions in the adhesive polymer resin while being electrically connected with each other from one surface of the adhesive tape to the other surface of the adhesive tape.

The present invention also provides a method for producing an adhesive tape, which shows conductivity along its transverse direction as well as its longitudinal direction and has different adhesion values on both surfaces thereof, the method comprising the steps of: mixing monomers for an adhesive polymer resin with conductive fillers; forming the resultant mixture into a sheet; and irradiating both surfaces of the sheet with light to perform photopolymerization of the adhesive polymer resin, wherein the light irradiated to each surface of the sheet has a different light intensity and the light is irradiated selectively to a part of the sheet surface.

The adhesive tape according to the present invention shows adhesiveness and conductivity by itself, and thus can be used for various applications, including electromagnetic wave-shielding adhesives. Additionally, the adhesive tape according to the present invention shows a strong adhesion value on one surface so as to be used desirably for the purpose of housing, while having such a degree of adhesion that it can be removed with ease on the other surface, thereby providing excellent workability.

### BRIEF DESCRIPTION OF THE DRAWINGS

The foregoing and other objects, features and advantages of the present invention will become more apparent from the following detailed description when taken in conjunction with the accompanying drawings in which:

FIG. 1a is a photographic view showing the top surface (irradiated with UV rays under low intensity) and the bottom surface (irradiated with UV rays under high intensity) of an adhesive tape according to one embodiment of the present invention, which is obtained by irradiating each surface of an adhesive polymer resin comprising conductive fillers with light under different intensity;

FIG. 1b is a photographic view showing the top surface and the bottom surface of an adhesive tape, which is obtained by irradiating both surfaces of an adhesive resin with light under the same intensity;

FIG. 2a is a schematic view showing fillers aligned in the adhesive tape as shown in FIG. 1a;

FIG. 2b is a photographic view taken by a SEM (scanning electron microscope), which shows a sectional shape of an adhesive tape and fillers aligned therein according to one embodiment of the present invention;

FIG. 2c is a photographic view taken by a SEM, which shows a surface of an adhesive tape and fillers aligned therein according to one embodiment of the present invention;

FIG. 2d shows an example of the present invention, wherein a conductive mesh film that is prepared by coating a conductive mesh with polymer resin is used as a mask having a masking pattern, and the conductive mesh film is incorporated in the adhesive tape.

FIG. 3 is a schematic view showing a masking pattern applicable to a release sheet according to one embodiment of the present invention;

FIGS. 4a and 4b are schematic views showing the alignment of fillers being changed upon the light irradiation according to one embodiment of the present invention; and

FIGS. 5a and 5b are graphs showing the initial adhesion (FIG. 5a) of the top surface and the bottom surface of an adhesive tape, which is obtained by using light with different intensity, and the aged adhesion (FIG. 5b) thereof, measured after a lapse of one week at 65° C.

### DETAILED DESCRIPTION OF THE INVENTION

Reference will now be made in detail to the preferred embodiments of the present invention.

According to the present invention, the adhesive tape 100 may be produced in the form of a sheet. In the adhesive tape 100, the conductive fillers 120 are aligned along the transverse direction 130 as well as the longitudinal direction 140 of the adhesive tape 100. Such alignment of the conductive fillers 120 allows the conductive fillers 120 to be connected electrically to each other from one surface of the adhesive tape 100 to the other surface of the adhesive tape 100. That is, the conductive fillers 120 can form a conductive network over the whole area of the adhesive tape 100.

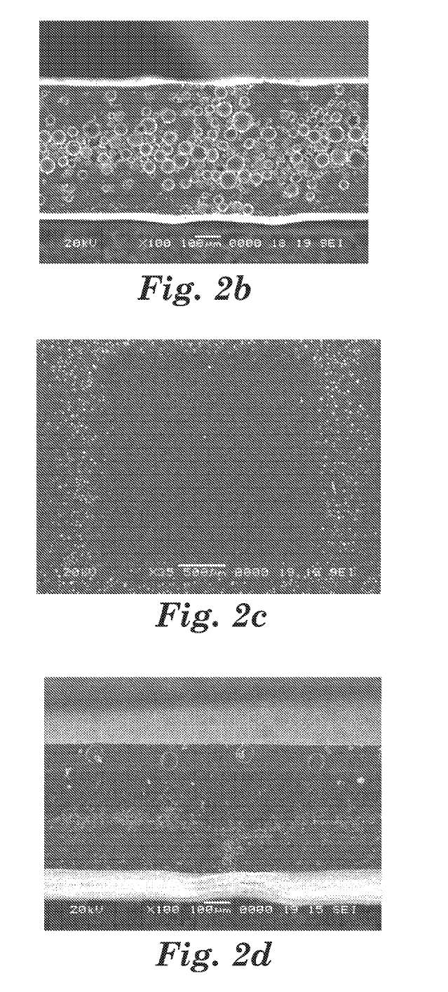

FIGS. 2a-2c show embodiments of the conductive fillers 120 aligned in the adhesive tape 100 according to the present invention. The adhesive tape 100 allows electric current to flow through the network formed by the conductive fillers 120 as shown in FIGS. 2a-2c.

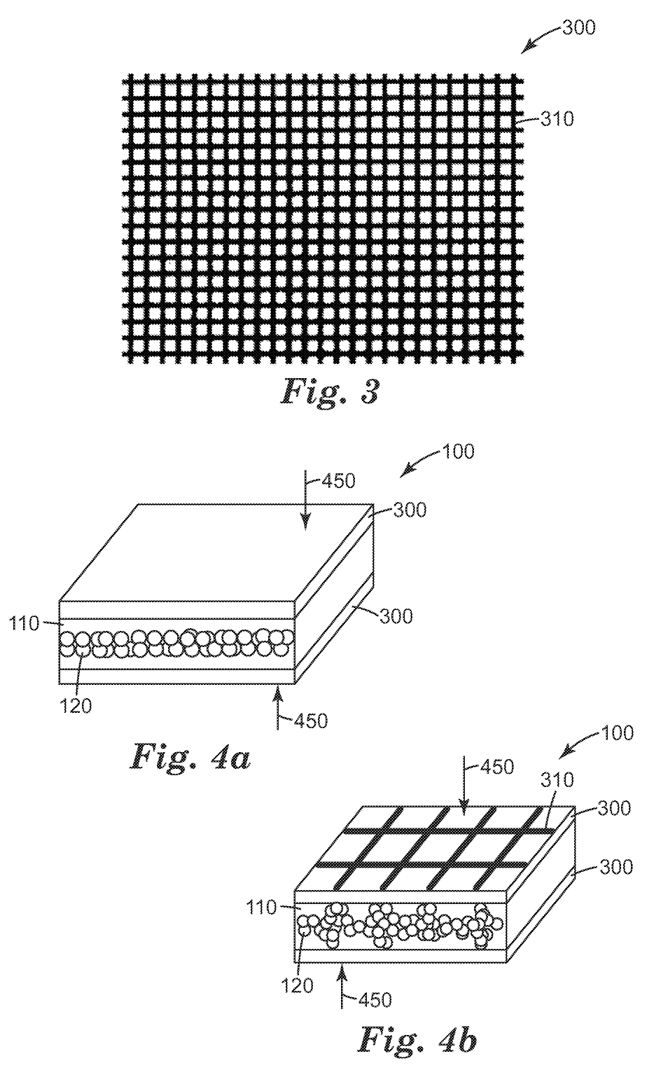

According to the present invention, in order to allow the conductive fillers 120 to be aligned along the transverse direction 130 as well as the longitudinal direction 140 of the adhesive polymer resin, mobility of the fillers 120 can be utilized during the polymerization process. In detail, when performing the photopolymerization process by irradiating light 450 onto a syrup-state polymer composition 110 after adding conductive fillers 120 to the syrup-state polymer composition 110 (hereinafter, referred to also as “polymer syrup 110”), in which monomers have not yet been completely cured, the light 450 is selectively irradiated to the surface of the polymer syrup 110 in such a manner that photopolymerization is selectively initiated on the surface of the polymer syrup 110, thereby aligning the conductive fillers 120 in a desired pattern. To accomplish such selective initiation of polymerization, a mask having a desired masking pattern 310, for example a release sheet 300 having a masking pattern 310, can be used (see FIG. 3).

More particularly, when irradiation is performed through the mask having a masking pattern 310, the light 450 cannot pass through the light-shielding area formed by the masking pattern 310 or the amount of light 450 passing through the mask may be significantly reduced, so that the photopolymerization is not initiated, or the photopolymerization speed is reduced or is very low even if the photopolymerization may be initiated (see FIG. 4b). However, photopolymerization may actively occur at an area, which is not affected by the masking pattern 310, thereby creating radicals. As a result, polymerization may proceed smoothly in the downward direction from the masking pattern 310.

When polymer syrup 110 containing fillers 120 begins to be polymerized from the surface by the light irradiation, the fillers 120 remaining in an area where the polymerization is initiated are shifted into an area where the polymerization is not yet initiated. That is, when photopolymerization proceeds from both surfaces of the polymer syrup 110, polymerization is initiated from the surface and the conductive fillers 120 remaining in the surface are shifted into an internal intermediate layer where polymerization is not yet initiated (see FIG. 4a). In contrast, since polymerization is not initiated in the area formed below the masking pattern 310, conductive fillers 120 remaining in the above area are not shifted downwardly (see FIG. 4b).

Accordingly, as shown in FIGS. 2a-2c, the conductive fillers 120 are concentrated in the central portion (when viewed from the longitudinal direction 140) of the sheet at an area where the masking pattern 310 is not formed, and are retained in the longitudinal direction 140 at an area where the masking pattern 310 is formed, thereby forming the conductive network over the whole area of the polymer resin sheet. That is, the conductive fillers 120 are aligned along the longitudinal direction 140 (z-axis direction) of the polymer resin sheet at the area where the masking pattern 310 is formed and are aligned in the intermediate layer of the polymer resin sheet along the transverse direction 130 (x-y plane) at the area where the masking pattern 310 is not formed, thereby forming the conductive network in the longitudinal and transverse directions 130 of the adhesive polymer sheet. Therefore, the conductive fillers 120 can be electrically connected to each other from one surface of the adhesive tape 100 to the other surface of the adhesive tape 100. Thus, the adhesive tape 100 according to the present invention may have superior electroconductivity as compared to a conventional adhesive tape 100 in which the conductive fillers 120 are randomly distributed.

Additionally, when each surface of the polymer syrup 110 for forming the adhesive tape 100 is irradiated with light 450 under different intensity, the mobility of the fillers 120 is changed, and thus the adhesive tape 100 has different adhesion values on both surfaces thereof. For example, on the surface irradiated with light 450 under higher intensity, photopolymerization of the polymer syrup 110 proceeds more promptly, resulting in an increase in the mobility of the fillers 120. Thus, the fillers 120 to be aligned in the transverse direction 130 tend to lean to the side irradiated with light 450 under lower intensity. That is, the fillers 120 to be aligned on the x-y plane are displaced more closely to the surface irradiated with light 450 under lower intensity, as compared with the surface irradiated with light 450 under higher intensity (see FIG. 2a). In addition, on the surface irradiated with light 450 under higher intensity, rapid photopolymerization occurs, and thus the fillers 120 move rapidly, resulting in formation of surface roughness.

Meanwhile, the adhesive polymer layer formed at the side irradiated with light 450 under higher intensity is thicker than the adhesive polymer layer formed at the side irradiated with light 450 under lower intensity, because the fillers 120 aligned on the x-y plane lean to the latter side. However, the surface irradiated with light 450 under higher intensity may have a lower adhesion value due to the aforementioned surface roughness.

Therefore, it is possible to provide an adhesive tape 100, which has different adhesion values on both surfaces thereof while showing electroconductivity, by a single manufacturing process according to the present invention.

The adhesion value on each surface of the adhesive tape 100 depends on the particular use and target material of the adhesive tape 100. According to one embodiment of the present invention, one surface of the adhesive tape 100 may have an initial adhesion value of about 300-1000 gf/inch (116-386 centiNewtons/centimeter) and the other surface of the adhesive tape 100 may have an initial adhesion value of about 800-2500 gf/inch (309-965 centiNewtons/centimeter).

Although there is no particular limitation in the thickness of the adhesive tape 100, the adhesive tape 100 may have a thickness of about 0.2 mm-3 mm, considering photopolymerization characteristics, etc.

According to the present invention, the adhesive polymer resin may be used in an amount of about 10-95 wt % based on the total weight of the adhesive tape 100.

In the present invention, an acryl-based polymer resin may be used as the adhesive polymer resin. According to a preferred embodiment of the present invention, an acryl-based polymer that can be obtained from the polymerization of photopolymerizable monomers may be used.

The photopolymerizable monomer includes alkyl acrylate monomer having a C1-C14 alkyl group. Non-limiting examples of the alkyl acrylate monomer include butyl (meth)acrylate, hexyl (meth)acrylate, n-octyl (meth)acrylate, isooctyl (meth)acrylate, 2-ethyl-hexyl (meth)acrylate, and isononyl (meth)acrylate. In addition, particular examples of the alkyl acrylate monomer that may be used in the present invention also include isooctyl acrylate, isononyl acrylate, 2-ethyl-hexyl acrylate, decyl acrylate, dodecyl acrylate, n-butyl acrylate, and hexyl acrylate.

Although the alkyl acrylate monomer can form the acryl-based adhesive polymer resin by homopolymerization, it may be copolymerized with a copolymerizable monomer having a polarity different from that of the alkyl acrylate monomer in order to form the adhesive polymer resin. That is, according to an embodiment of the present invention, it is also possible to use a copolymer of a C1-C14 alkyl acrylate monomer with a polar copolymerizable monomer, as the acryl-based adhesive polymer resin.

Herein, there is no particular limitation in the ratio of the alkyl acrylate monomer to the polar copolymerizable monomer. However, a weight ratio of 99-50:1-50 can be adopted, considering the physical properties of the resultant adhesive polymer resin.

Non-limiting examples of the polar copolymerizable monomer include acrylic acid, itaconic acid, hydroxyalkyl acrylate, cyanoalkyl acrylate, acrylamide, substituted acrylamide, N-vinyl pyrrolidone, N-vinyl caprolactam, acrylonitrile, vinyl chloride, and diallyl phthalate.

The polar copolymerizable monomer imparts adhesive and coherent properties to the polymer resin while improving adhesion of the polymer resin.

The adhesive tape 100 according to the present invention comprises a conductive filler for imparting electroconductivity. Although there is no particular limitation in kind of the conductive filler, the conductive filler that may be used includes noble metals; non-noble metals; noble metal-plated noble or non-noble metals; non-noble metal-plated noble and non-noble metals; noble or non-noble metal plated non-metals; conductive non-metals; conductive polymers; and mixtures thereof. More particularly, the conductive filler that may include noble metals such as gold, silver, platinum; non-noble metals such as nickel, copper, tin, aluminum, and nickel; noble metal-plated noble or non-noble metals such as silver-plated copper, nickel, aluminum, tin, or gold; non-noble metal-plated noble and non-noble metals such as nickel-plated copper or silver; noble or non-noble metal plated non-metals such as silver or nickel-plated graphite, glass, ceramics, plastics, elastomers, or mica; conductive non-metals such as carbon black or carbon fiber; conductive polymers such as polyacetylene, polyaniline, polypyrrole, polythiophene, poly sulfurnitride, poly(p-phenylene), poly(phenylene sulfide) or poly(p-phenylenevinylene); and mixtures thereof.

The filler is broadly classified as “particulate” in form, although the particular shape of such form is not considered critical to the present invention, and may include any shape that is conventionally involved in the manufacture or formulation of conductive materials of the type herein involved including hollow or solid microspheres, elastomeric balloons, flakes, platelets, fibers, rods, irregularly-shaped particles, or a mixture thereof.

Similarly, the particle size of the filler is not considered critical, and may be or a narrow or broad distribution or range, but in one exemplary embodiment of the present invention will be between about 0.250-250 μm, and in another exemplary embodiment between about 1-100 μm.

The conductive fillers 120 may be used in an amount of 5-90 wt % based on the total weight of the adhesive tape 100 according to the present invention. According to an embodiment of the present invention, the adhesive tape 100 may comprise 40-80 wt % of the adhesive polymer resin and 20-60 wt % of the conductive fillers 120. According to another embodiment of the present invention, the conductive fillers 120 may be used in an amount of 100 to 500 parts by weight based on 100 parts by weight of the adhesive polymer resin.

In order to obtain physical properties required for a product, to which the adhesive tape 100 is applied, the adhesive tape 100 according to the present invention may further comprise at least one filler. There is no particular limitation in the type of fillers 120, as long as the filler does not adversely affect the characteristics and utility of the adhesive tape 100. For instance, the fillers include, but are not limited to, heat conductive fillers, flame-resistant fillers, anti-static agents, foaming agents and polymer hollow microspheres.

According to the present invention, the fillers may be used in an amount of less than 100 parts by weight, for example 10-100 parts by weight, based on 100 parts by weight of the adhesive tape 100.

In addition, the polymer resin may include other additives, such as polymerization initiators, cross-linking agents, photo-initiators, pigments, anti-oxidants, UV-stabilizers, dispersants, defoaming agents, thickening agents, plasticizers, tackifying resins, or glazing agents.

Hereinafter, the method for producing the adhesive tape 100 according to the present invention will be explained in more detail.

The adhesive tape 100 according to the present invention may be produced by mixing the monomer for forming the adhesive polymer resin with conductive fillers for imparting conductivity, adding fillers or additives thereto if necessary, and then carrying out polymerization of the resultant mixture. At this time, photopolymerization is carried out by irradiating each surface of the adhesive polymer resin with light 450 under different intensity, thereby providing the adhesive tape 100 having different adhesion values on both surfaces thereof.

In detail, the adhesive tape 100 according to the present invention, which shows conductivity along its longitudinal direction 140 as well as its transverse direction 130 and has different adhesion values on both surfaces thereof, can be produced by the method comprising the steps of:

mixing monomers for forming an adhesive polymer resin with conductive fillers;

forming the mixture in the form of a sheet; and

irradiating both surfaces of the sheet with light 450 to carry out photopolymerization of the adhesive polymer resin, wherein each surface of the sheet is irradiated with light 450 under different intensity and the light 450 is irradiated selectively to a part of the sheet surface. The method may further comprise a step of adding polymerization initiators or cross-linking agents.

According to one embodiment of the present invention, in order to allow the conductive fillers 120 to be distributed uniformly and to facilitate initiation of the aforementioned selective photopolymerization, the monomers for forming the adhesive polymer resin is preliminarily polymerized to provide polymer syrup 110, and then conductive fillers 120 and other additives are added to the polymer syrup 110. That is, the step for mixing monomers for forming the adhesive polymer resin with conductive fillers 120 may include the steps of: carrying out partial polymerization of the monomers for forming the adhesive polymer resin to form polymer syrup 110; and adding the conductive fillers 120 to the polymer syrup 110. According to an embodiment of the present invention, the polymer syrup 110 may have a viscosity of about 500-20,000 cps.

As mentioned above, an acryl-based polymer resin may be used as the adhesive polymer resin.

Therefore, according to an embodiment of the present invention, the adhesive tape 100 can be obtained by the method comprising the steps of:

carrying out partial polymerization of monomers for forming the adhesive polymer resin to form polymer syrup 110;

adding conductive fillers 120 to the polymer syrup 110 and uniformly mixing the mixture;

forming the polymer syrup 110 including the conductive fillers 120 added thereto into a sheet and aligning a mask having a predetermined masking pattern 310 on a surface of the sheet; and

irradiating light 450 to the sheet through the mask to perform photopolymerization, wherein each surface of the sheet is irradiated with light 450 under different intensity.

More particularly, the monomers for forming the adhesive polymer resin are partially polymerized by using a polymerization initiator under an oxygen-free condition to obtain polymer syrup 110 having a viscosity of about 500 to 20,000 cps. Then, the conductive fillers 120, other additives, cross-linking agents and photo-initiators are added to the polymer syrup 110, and then the mixture is formed into a sheet, which can be used as a tape. At this time, the polymer syrup 110 sheet may be interposed between release sheets 300 by using light-transmittable release sheets 300. Such disposition permits formation of the condition substantially free from oxygen. Additionally, if a masking pattern 310 is formed on the release sheet 300, the release sheet 300 may serve as a mask having a masking pattern 310. Then, the sheet is irradiated with light 450 (preferably UV rays) through the release sheet 300 or other mask having a masking pattern 310 so that the polymer syrup 110 is polymerized and cross-linked under the condition substantially free from oxygen. At this time, each surface of the polymer syrup 110 is irradiated with light 450 under different intensity in order to provide an adhesive tape 100 having different adhesion values on both surfaces thereof. By doing so, it is possible to obtain an adhesive tape 100 comprising a network formed by conductive fillers 120 and having different adhesion values on both surfaces thereof.

According to an embodiment of the present invention, a thixotropic material, such as fumed silica, can be employed if necessary, in order to sufficiently thicken the monomers so that the monomer can form syrup.

For instance, when both surfaces of the sheet are irradiated with light 450, oxygen content may be 1000 ppm or less. As the oxygen content decreases, undesired oxidation of the adhesive polymer resin can be inhibited more effectively, thereby providing an excellent adhesion value. In other words, after the polymer syrup 110 is interposed between release sheets 300 and the resultant mixture is formed into a sheet, the sheet may be irradiated with light 450 in a substantially oxygen-free chamber, where oxygen is present at a concentration of less than 1000 ppm, through a mask having a masking pattern 310. If desired, it is possible to adjust the oxygen concentration to 500 ppm or less.

In the step of photopolymerization, in order to accomplish selective irradiation on the polymer sheet, a mask having masking pattern 310 can be used. The mask having a predetermined masking pattern 310 includes a light-passing area for allowing the light 450 to pass therethrough and a light-shielding area for shielding or reducing the light 450 passing therethrough. The mask may include, but is not limited to, a light-transmittable release sheet 300 having a predetermined masking pattern 310, a mesh net, a mesh, or a lattice. According to an embodiment of the present invention, the light-transmittable release sheet 300 having a predetermined masking pattern 310 may be used as the mask (see FIG. 3). Herein, the light-transmittable release sheet 300 that may be used includes a transparent plastic film treated with a release coating agent or having lower surface energy. For instance, the light-transmittable release sheet 300 can be fabricated by using a plastic film, such as a polyethylene film, a polypropylene film or a polyethylene terephthalate (PET) film.

Meanwhile, in order to form the masking pattern 310, a material capable of masking the light 450 arriving at the masking part to a ratio of 10-100%, preferably to a ratio of 50% or more, may be used. According to an embodiment of the present invention, the masking pattern 310 may be designed in such a manner that it can shield the light 450 arriving at the masking pattern 310 to a ratio of 70% or more. If necessary, the masking pattern 310 may be designed in such a manner that it can completely (100%) shield the light 450 arriving at the masking pattern 310.

There is no particular limitation in the method for forming the masking pattern 310 on the surface of the light-transmittable release sheet 300. Any methods that permit a material for forming the masking pattern 310, which can reduce light transmission or can shield the light transmission, to be applied onto the light-transmittable release sheet 300 can be used with no limitation. For example, a printing method may be used. The printing method includes a currently used printing method, such as a screen printing method, a printing method using a heat transfer sheet, or a gravure printing method. To form the masking pattern 310, it is also possible to use black ink having excellent light absorptivity. The figure of the masking pattern 310 is not limited, for example, the masking pattern 310 shown in FIG. 3 may be adopted.

There is no particular limitation in the type of the masking pattern 310 formed in the release sheet 300. According to an embodiment of the present invention, a light shielding section formed by the masking pattern 310 may occupy 1 to 70% of the release sheet 300. If the area of the light shielding section is less than 1% of the release sheet 300, the conductive fillers 120 cannot be efficiently aligned in the longitudinal direction 140. In contrast, if the area of the light shielding section exceeds 70% of the release sheet 300, it may interrupt photopolymerization.

Although there is no particular limitation in the thickness of the release sheet 300, a release sheet 300 having a thickness of about 5 μm-2 mm may be used according to an embodiment of the present invention. If the release sheet 300 has a thickness of less than 5 μm, the release sheet 300 is too thin to form a pattern and to apply polymer syrup 110 thereon. It is not necessary to use a release sheet 300 having an excessively large thickness. This is because a release sheet 300 having a thickness of greater than 2 mm may interrupt photopolymerization.

In one embodiment of the present invention, as a mask having masking pattern 310 for the selective irradiation, a conductive mesh film may be used. The conductive mesh film can be prepared by coating a conductive mesh with polymer resin. In the conductive mesh film, the conductive mesh does not pass light 450 therethrough and thus can function as a masking pattern 310; and the conductive mesh has conductivity. The conductive mesh film selectively shields light 450 passing through to make selective photopolymerization, however conductive mesh film is not removed after photopolymerization, but is incorporated into the adhesive tape 100 to form one side of the adhesive tape 100. When the conductive mesh film is used, different adhesion value can be accomplished easily.

Thickness of the conductive mesh film is not limited, but a thickness may be about 5 μm-2 mm according to one embodiment of the present invention.

In addition, there is no particular limitation in the thickness of the adhesive tape 100 according to the present invention. For instance, the adhesive tape 100 may have a thickness of about 25 μm to 3 mm by taking photopolymerizability of the monomers and mobility of the conductive fillers 120 into consideration. If the thickness of the adhesive tape 100 is less than 25 μm, workability may be degraded due to the thin thickness of the adhesive tape 100. In contrast, if the thickness of the adhesive tape 100 exceeds 3 mm, it may interrupt photopolymerization.

The light 450 has intensity adaptable for typical photopolymerization. According to an embodiment of the present invention, the light 450 has intensity identical to that of UV rays. In addition, irradiation time may be changed depending on the light 450 intensity during the photopolymerization process. According to the present invention, both surfaces of the polymer syrup 110 sheet for forming the adhesive tape 100 are irradiated with light 450 under different intensity. That is, one surface is irradiated with light 450 under relatively high intensity, while the other surface is irradiated with light 450 under relatively low intensity. The low intensity may be 10-90% of the high intensity.

According to the present invention, a crosslinking agent may be used to perform crosslinking of the adhesive polymer resin. Properties of the adhesive polymer resin, in particular, adhesive property of the adhesive polymer resin can be adjusted depending on the amount of the cross-linking agent. For example, the cross-linking agent may be used in an amount of about 0.05 to 2 parts by weight based on 100 parts by weight of the adhesive polymer resin. Particular examples of the cross-linking agent that may be used in the present invention include multi-functional acrylate, such as 1,6-hexanediol diacrylate, trimethylopropane triacrylate, pentaerythritol triacrylate, 1,2-ethylene glycol diacrylate, or 1,12-dodecanediol acrylate. However, the present invention is not limited thereto.

In addition, a photo-initiator can be used during the production of the adhesive tape 100. The polymerization degree of the polymer resin can be adjusted depending on the amount of the photo-initiator. For example, the photo-initiator may be used in an amount of about 0.01 to 2 parts by weight based on 100 parts by weight of the adhesive polymer resin. Particular examples of the photo-initiator that may be used in the present invention include 2,4,6-trimethylbenzoyldiphenyl phosphineoxide, bis(2,4,6-trimethylbenzoyl)phenylphosphineoxide, α,α-methoxy-α-hydroxyacetophenone, 2-benzoyl-2(dimethyl amino)-1-[4-(4-morphonyl)phenyl]-1-butanone, or 2,2-dimethoxy 2-phenyl acetophenone. However, the present invention is not limited thereto.

According to an embodiment of the present invention, in order to improve flexibility of the adhesive tape 100, the adhesive tape 100 can be subjected to a foaming process. The foaming process includes various foaming schemes, such as mechanical distribution of foam through the injection of a gaseous foaming agent, dispersion of hollow polymer microspheres, or use of a thermal foaming agent. Non-limiting examples of the foaming agent include, but are not limited to: water; volatile organic compounds (VOC) such as propane, n-butane, isobutane, butylene, isobutene, pentane, neopentane or hexane; and inert gases such as nitrogen, argon, xenon, krypton, helium, or CO₂. The foaming agent may be added to partially polymerized polymer syrup 110.

Hereinafter, the present invention will be described in detail with reference to examples, comparative examples and experimental examples, which are for illustrative purposes only and are not intended to limit the scope of the present invention.

In the following description, the term “parts” refers to “parts by weight” based on 100 parts by weight of the adhesive polymer resin obtained from the polymerization of the monomers.

### EXAMPLES 1-4 AND COMPARATIVE EXAMPLE 1

First, 93 parts of 2-ethylhexyl acrylate as an acrylic monomer, 7 parts of acrylic acid as a polar monomer, and 0.04 parts of Irgacure-651 (α,α-methoxy-α-hydroxyacetophenone) as a photoinitiator, were partially polymerized in a 1 L glass reactor to obtain syrup with a viscosity of 3000 cps. Next, 100 parts of the syrup were mixed with 0.1 part of Irgacure-819 [Bis (2,4,6-trimethylbenzoyl)phenyl-phosphineoxide] as a photoinitiator, 0.65 parts of 1,6-hexanediol diacrylate (HDDA) as a cross-linking agent, and 1.5 parts of fumed silica, and the mixture was sufficiently stirred. Then, 30 parts of silver coated hollow glass spheres (SH230S33, Potters Industries Inc.) having a particle size of about 44 μm were mixed with the above mixture as electroconductive fillers, and then the resultant mixture was stirred thoroughly to a uniform state, thereby providing a mixture in the form of polymer syrup.

Meanwhile, as shown in FIG. 3, the lattice having a width of 700 μm and an interval of 1.5 mm was patterned on a transparent polypropylene film having a thickness of 75 μm by using black ink to provide a mask having a masking pattern in the form of a release sheet.

Then, the polymer syrup was extruded from the glass reactor and the patterned release sheets were aligned on both surfaces of the polymer syrup by using a roll coating device in such a manner that the polymer syrup could be positioned between the release sheets with a thickness of about 0.5 mm. Since the release sheets were aligned on both surfaces of the polymer syrup, the polymer syrup was prevented from contacting with air, especially, oxygen.

Then, UV rays were irradiated to the release sheet having the masking pattern by using a metal halide UV lamp under the intensity as shown in the following Table 1 to provide adhesive tapes, which were designated as Examples 1, 2 and 3 and Comparative Example 1. For convenience, UV rays with high intensity were irradiated to the bottom surface (B), while UV rays with low intensity were irradiated to the top surface (T). In Comparative Example 1, UV rays were irradiated to both of the bottom surface and the top surface under the same intensity.

Meanwhile, when irradiating the adhesive tapes with UV rays, each of the adhesive tape samples according to Examples 1-3 and Comparative Example 1 was divided into three zones (Zone 1, Zone 2 and Zone 3), and each zone was irradiated with UV rays under predetermined intensity.

TABLE 1

| | UV intensity mW/cm² | | | | | | | |
|---|---|---|---|---|---|---|---|---|
| | Zone 1 | | Zone 2 | | Zone 3 | | | |
| Sample | (T:B) | | (T:B) | | (T:B) | | Line Speed | Thickness |
| Comp. Ex. | 4.1 | 4.1 | 4.1 | 4.1 | 4.1 | 4.1 | 0.5 mpm | 500 μm |
| 1 | | | | | | | (520 Sec.) | |
| Ex. 1 | 2.8 | 4.1 | 2.8 | 4.1 | 2.8 | 4.1 | | |
| Ex. 2 | 1.3 | 4.1 | 1.3 | 4.1 | 1.3 | 4.1 | | |
| Ex. 3 | 0.2 | 4.1 | 2.8 | 4.1 | 4.1 | 4.1 | | |

The adhesive tapes were observed to determine the distribution of the fillers. FIGS. 2a to 2c are photographic views taken by an SEM (scanning electron microscope), which show the section of the adhesive tape according to Example 1.

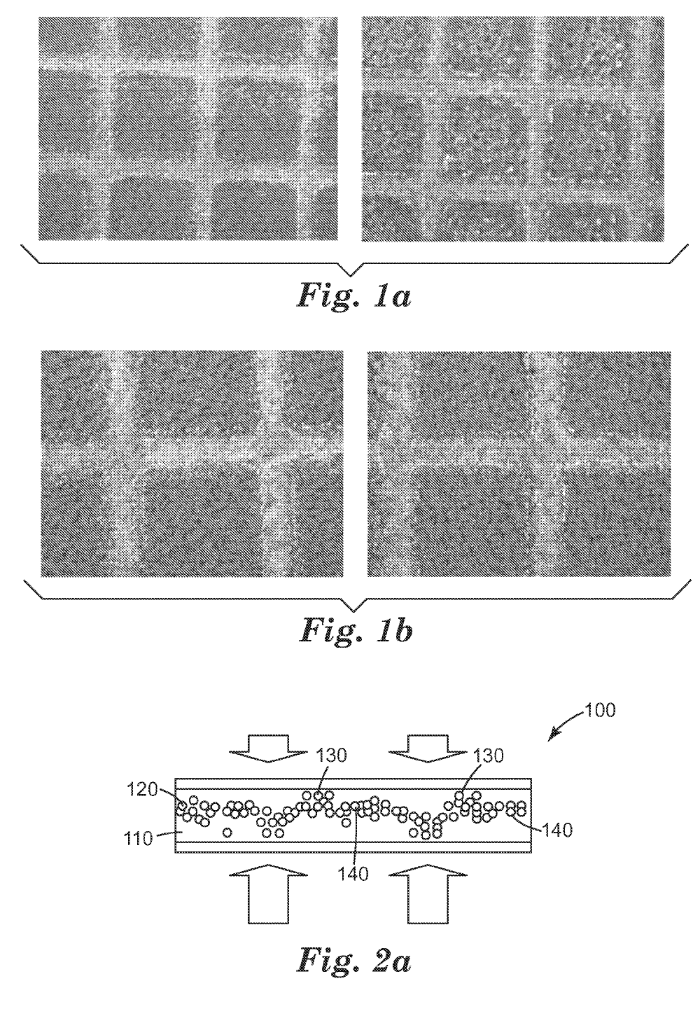

As shown in FIGS. 2a to 2c, the conductive fillers are aligned in the longitudinal direction (z-axis direction) of the adhesive polymer sheet in the area, where the masking pattern is formed, and are aligned in the transverse direction (x-y plane) of the adhesive polymer sheet at the middle portion of the adhesive polymer sheet in the area, where the masking pattern is not formed, thereby forming the conductive network over the whole area (along the x-y direction as well as the z-direction) of the adhesive polymer sheet. Additionally, it can be seen that the fillers aligned in the transverse direction (x-y plane) lean to the top surface irradiated with light under low intensity (see FIG. 2a). Herein, FIG. 1a is a photographic view showing the top surface and the bottom surface of the adhesive tape obtained from Example 1 according to the present invention. FIG. 1b is a photographic view showing the top surface and the bottom surface of the adhesive tape obtained from Comparative Example 1.

### EXPERIMENTAL EXAMPLE 1

### Resistance Measurement

Surface resistance values were measured at the three zones of each of the adhesive tape obtained from Examples 1-3 and Comparative Example 1, according to the surface probe method defined by ASTMD991, by using Kiethely 580 micro-ohmmeter. The average resistance of the measured values was determined as the surface resistance of each adhesive tape. The results are shown in the following Table 2.

TABLE 2

| | |
|---|---|
| | Surface Resistance (T:B), |
| Sample | Ohms/sq |

| | | |
|---|---|---|
| Comp. Ex. 1 | 0.44 | 0.48 |
| Ex. 1 | 0.41 | 0.42 |
| Ex. 2 | 0.44 | 0.43 |
| Ex. 3 | 0.49 | 0.44 |

### EXPERIMENTAL EXAMPLE 2

### Adhesion Force Test

After laminating aluminum with each of the adhesive tape obtained from Examples 1-3 and Comparative Example 1, adhesion force of each adhesive tape to steel was measured in the direction of 90°. For each adhesive tape, initial adhesion and aged adhesion were measured at 25° C.

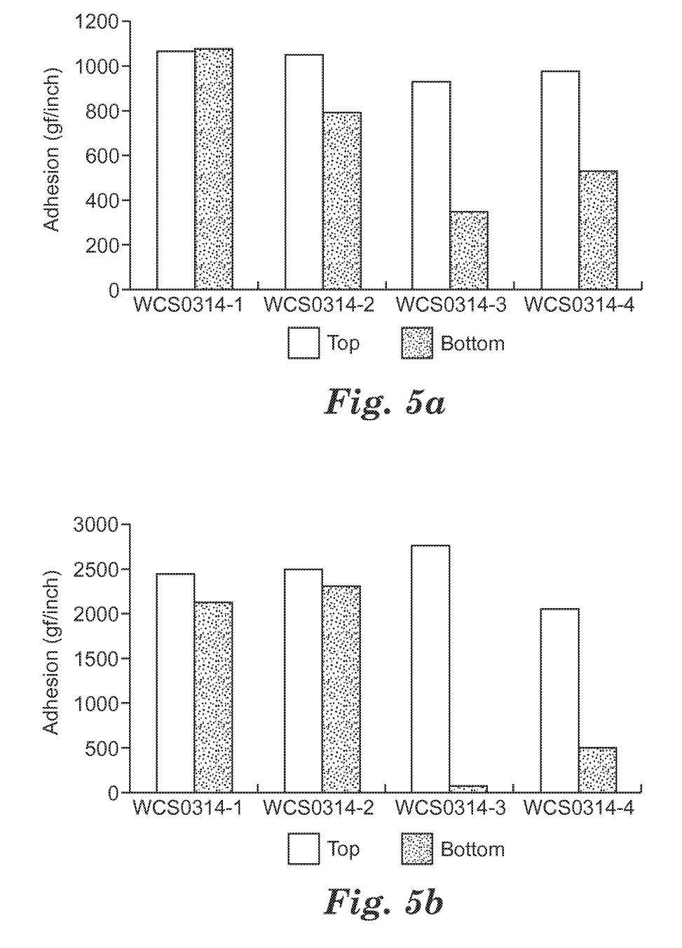

Herein, the initial adhesion was defined as the adhesion value measured after a lapse of 20 minutes at 25° C., and the aged adhesion was defined as the adhesion value measured after a lapse of one week at 65° C. The results are shown in the following Table 3. For the convenience of comparison, the same results are shown in FIGS. 5a and 5b in a graph form.

TABLE 3

| | | |
|---|---|---|
| | Initial Adhesion | Aged Adhesion |
| | (gf/inch) | (gf/inch) |
| Sample | (T:B) | (T:B) |

| | | | | |
|---|---|---|---|---|
| Comp. Ex. 1 | 1065 | 1073 | 2457 | 2131 |
| Ex. 1 | 1051 | 796 | 2497 | 2310 |
| Ex. 2 | 934 | 353 | 2774 | 88 |
| Ex. 3 | 979 | 529 | 2063 | 506 |

As can be seen from the above experimental results, the adhesive tape according to the present invention not only shows excellent conductivity but also has different adhesion values on both surfaces thereof. It can be also seen that the adhesion value at the bottom surface decreases as the intensity of the light irradiated to the top surface increases, while not significantly affecting the adhesion value at the top surface.

As described above, the adhesive tape according to the present invention includes conductive fillers aligned in the longitudinal direction as well as the transverse direction, so that the adhesive tape has superior conductivity. Additionally, since the adhesive tape according to the present invention has different adhesion values on both surfaces thereof, it can be used for various applications, requiring a high adhesion value on one side and a low adhesion value on the other side. Thus, when the adhesive tape according to the present invention is used as a gasket for packing an electronic appliance, the adhesive tape can effectively protect the electronic components installed in the electronic appliance, by virtue of its impact and vibration-absorbing properties and excellent electromagnetic wave-shielding property.

1. An adhesive tape comprising an adhesive polymer resin and conductive fillers distributed in the adhesive polymer resin, wherein the tape has different adhesion values on both surfaces thereof, wherein the conductive fillers are aligned in both longitudinal and transverse directions in the adhesive polymer resin while being electrically connected with each other from one surface of the adhesive tape to the other surface of the adhesive tape.

2. The adhesive tape of claim 1, which has a thickness of about 25 μm to 3 mm.

3. The adhesive tape of claim 1, which has an initial adhesion value of about 300-1000 gf/inch on one surface, and an initial adhesion value of about 800-2500 gf/inch on the other surface.

4. The adhesive tape of claim 1, wherein the conductive fillers are present in an amount of 10 to 500 parts by weight based on 100 parts by weight of the adhesive polymer resin.

5. The adhesive tape of claim 1, wherein the adhesive polymer resin includes an acrylic polymer resin, optionally wherein the acrylic polymer resin includes a polymer obtained by copolymerizing an alkyl acrylate monomer having a C1-C14 alkyl group with a polar copolymerizable monomer.

6. (canceled)

7. The adhesive tape of claim 5, wherein the alkyl acrylate monomer is selected from butyl (meth)acrylate, hexyl (meth)acrylate, n-octyl (meth)acrylate, isooctyl (meth)acrylate, 2-ethylhexyl (meth)acrylate, isononyl (meth)acrylate, isooctyl acrylate, isononyl acrylate, 2-ethylhexyl acrylate, decyl acrylate, dodecyl acrylate, n-butyl acrylate, and hexyl acrylate.

8. The adhesive tape of claim 5, wherein the polar copolymerizable monomer is selected from acrylic acid, itaconic acid, hydroxyalkyl acrylate, cyanoalkyl acrylate, acrylamide, substituted acrylamide, N-vinyl pyrrolidone, N-vinyl caprolactam, acrylonitrile, vinyl chloride, and diallyl phthalate.

9. The adhesive tape of claim 5, wherein the alkyl acrylate monomer and the polar copolymerizable monomer are used in a ratio of 99-50:1-50.

10. The adhesive tape of claim 1, wherein the conductive filler is selected from noble metals; non-noble metals; noble metal-plated noble or non-noble metals; non-noble metal-plated noble and non-noble metals; noble or non-noble metal plated non-metals; conductive non-metals; conductive polymers; and mixtures thereof.

11. The adhesive tape of claim 10, wherein
the noble metals include gold, silver, platinum,
the non-noble metals include nickel, copper, tin, aluminum, and nickel;
the noble metal-plated noble or non-noble metals include silver-plated copper, nickel, aluminum, tin, and gold;
the non-noble metal-plated noble and non-noble metals include nickel-plated copper and silver;
the noble or non-noble metal plated non-metals include silver or nickel-plated graphite, glass, ceramics, plastics, elastomers, and mica;
the conductive non-metals include carbon black and carbon fiber; and
conductive polymers include polyacetylene, polyaniline, polypyrrole, polythiophene poly sulfurnitride poly(p-phenylene), poly(phenylene sulfide) and poly(p-phenylenevinylene).

12. (canceled)

13. The adhesive tape of claim 1, which further comprises at least one filler selected from the group consisting of heat conductive fillers, flame-resistant fillers, anti-static agents, foaming agents and polymer hollow microspheres.

14. The adhesive tape as claimed in claim 1, wherein a conductive mesh film that is coated with polymer resin is positioned on one side of the adhesive tape.

15. A method for producing an adhesive tape having conductivity in both longitudinal and transverse directions, which comprises:
mixing monomers for forming an adhesive polymer resin with conductive fillers;
forming the mixture in the form of a sheet; and
irradiating both surfaces of the sheet with light to carry out photopolymerization of the adhesive polymer resin, wherein each surface of the sheet is irradiated with light under different intensity and the light is irradiated selectively to a part of the sheet surface.

16. The method as claimed in claim 15, wherein mixing monomers for forming the adhesive polymer resin with the conductive fillers includes:
forming polymer syrup by partially polymerizing the monomers for the adhesive polymer resin; and
adding the conductive fillers to the polymer syrup obtained by partially polymerizing the monomer.

17. (canceled)

18. The method of claim 15, wherein both surfaces of the sheet are irradiated with light under a condition where oxygen is present at a concentration of 1000 ppm or less.

19. The method of claim 15, wherein a mask having a masking pattern is aligned on the surface of the sheet and the light is irradiated through the mask, so as to irradiate the light selectively to a part of the surface of the sheet in the step of irradiating both surfaces of the sheet with light.

20. The method as claimed in claim 19, wherein the mask includes a mesh net, a lattice, a light-transmittable release film having a predetermined masking pattern or a conductive mesh film coated with polymer resin.

21. (canceled)

22. The method as claimed in claim 20, wherein the pattern formed on the light-transmittable release film is a pattern for preventing light transmission, and a light shielding section formed by the pattern occupies 1 to 70% of the release sheet.

23. (canceled)

24. The method as claimed in claim 20, wherein the conductive mesh film is not removed after photopolymerization, and is incorporated into the adhesive tape to form one side of the adhesive tape.

25. (canceled)

26. (canceled)

27. (canceled)

28. A method for producing an adhesive tape, which comprises:
carrying out partial polymerization of monomers for forming an adhesive polymer resin to form a polymer syrup;
adding conductive fillers to the polymer syrup and uniformly mixing the mixture;
forming the polymer syrup including the conductive fillers added thereto into a sheet and aligning a mask having a predetermined masking pattern on a surface of the sheet; and
irradiating light to the sheet through the mask to perform photopolymerization, wherein each surface of the sheet is irradiated with light under different intensity.
